(19) United States
(12) Patent Application Publication
(10) Pub. No.: US 2024/0344710 A1
(43) Pub. Date: Oct. 17, 2024

(54) SENSOR DEVICE, HEATING MEANS WITH A SENSOR DEVICE AND COOKTOP WITH MULTIPLE HEATING MEANS

(71) Applicant: E.G.O. Elektro-Gerätebau GmbH, Oberderdingen (DE)

(72) Inventors: Thomas Föller, Schwaigern (DE); Konstantin Freis, Bretten (DE)

(21) Appl. No.: 18/626,546

(22) Filed: Apr. 4, 2024

(30) Foreign Application Priority Data
Apr. 11, 2023 (DE) 10 2023 109 093.3

(51) Int. Cl. F24C 7/08; F24C 7/06; H05B 6/06

(52) U.S. Cl. CPC F24C 7/083; F24C 7/062; H05B 6/062; H05B 2213/07

(57) ABSTRACT

A sensor device for a cooktop has a sensor element and a retaining means therefor of plastics material, wherein the retaining means has an upper retaining region in which the sensor element is held precisely in position and has a fastening portion connected to the retaining region. The fastening portion protrudes at right angles from a longitudinal direction of the retaining region and has fastening projections and fastening recesses for form-locking fastening of the sensor device in the outer region of a heating means of the cooktop. The at least one fastening projection protrudes laterally for engagement in the heating means, in order to be fastened thereto.

### CROSS-REFERENCE TO RELATED APPLICATIONS

This application claims priority to German Application No. 10 2023 109 093.3, filed Apr. 11, 2023, the contents of which are hereby incorporated herein in its entirety by reference.

### FIELD OF APPLICATION AND BACKGROUND OF THE INVENTION

The invention relates to a sensor device for a cooktop or for use in a cooktop, to a heating means with an induction heating coil and with such a sensor device and to a cooktop which has multiple such heating means and sensor devices. The sensor device is here intended above all to detect a temperature, in particular at a cooktop plate of an above-stated cooktop below which multiple such heating means are arranged.

It is known to mount a temperature sensor at the top of an induction heating coil. This temperature sensor rests against the underside of a cooktop plate below which the induction heating coil is arranged. This temperature sensor is on the one hand mounted centrally to the induction heating coil, while on the other hand it is also mounted directly to the induction heating coil.

It is known from U.S. Pat. No. 10,271,386 B2 to arrange inductively operating pan detection sensors and also temperature sensors between neighboring induction heating coils or above an intermediate region, wherein these sensors are likewise pressed against the underside of a cooktop plate extending thereover. A temperature sensor is here configured as a discrete component, in particular as a THT component.

### OBJECT AND ACHIEVEMENT THEREOF

The object of the present invention is to provide a sensor device as mentioned above, a heating means provided therewith and a cooktop with multiple such heating means and sensor devices, with which prior art problems can be solved and it is in particular possible to arrange or mount a sensor element simply and practically and with maximally versatile usability respectively in a cooktop or to heating means.

This object is achieved by a sensor device having the features of claim 1, by a heating means having the features of claim 15 and by a cooktop having the features of claim 23. Advantageous and preferred embodiments of the invention are the subject matter of further claims and are explained in greater detail below. Some of the features are described here only for the sensor device, only for the heating means or only for the cooktop. Regardless of this, however, they are intended to apply by themselves and independently of one another for such a sensor device, such a heating means and also such a cooktop. The wording of the claims is incorporated by express reference into the content of the description.

The sensor device for a cooktop or for a heating means in the cooktop has a sensor element, which in turn has electrical connectors. These electrical connectors are advantageously embodied as cables, such that the sensor element advantageously has one twin-core or two single-core connecting cables. It may thus be connected to a controller, in particular a cooktop controller, for evaluation purposes. A retaining means is provided for the sensor element which holds the sensor element preferably in a precisely predetermined position and orientation, in particular during or after installation in a cooktop according to the invention. The sensor element advantageously takes the form of a discrete component, for example a THT component or a component similar to a THT component, i.e. with a housing and the above-stated electrical connectors, which may be of wire-like and protruding configuration. The retaining means consists of plastics material and has an upper retaining region, in which the sensor element is held precisely in position. In this respect, the sensor element is held in such a way that it projects beyond the retaining means or projects therefrom, in particular in the case of subsequent installation, in such a way that it forms the highest point of the sensor device or indeed projects beyond a heating means to which it is mounted or together with which it is arranged in a cooktop. The retaining region is here of elongate configuration, advantageously being at least three times as long as it is wide, such that its length may amount to at least 200% of its width.

Furthermore, the retaining means has a fastening portion which is connected, in particular is connected integrally and in one piece, to the retaining region. They may thus take the form of a common plastics part. The fastening portion is advantageously arranged or configured below the retaining region. This at least one fastening portion protrudes laterally from a longitudinal direction of the retaining region, in particular in a direction of between 80° and 100°, advantageously at right angles. It may protrude laterally by different extents, as will be explained in greater detail below. This lateral protrusion of the fastening portion serves to fasten the sensor device to a heating means.

According to the invention, the protruding fastening portion has fastening projections and fastening recesses, with which the sensor device may be arranged or fastened in form-locking manner in the outer region of the heating means. It is to this end that it protrudes laterally and thus projects away from the retaining region or the projection thereof, such that it engages at least to an extent in the heating means, so as to be fastened thereto. The invention thus makes it possible to arrange a sensor device in a cooktop or on the outside of a heating means therefor, i.e. advantageously between two neighboring heating means. Thus, something may on the one hand be measured in this region, in particular a temperature. On the other hand, this does not in any way impair functioning of the heating means or its heating action, since the sensor device or at least the sensor element is not arranged thereon or thereover but rather to the side thereof.

In one development of the invention, the retaining means may have in said retaining region, as a specific development, a trough-like, elongate sensor element receptacle, within which the sensor element is arranged. The latter may for example be held clamped in the sensor element receptacle, at least in force-locking manner but advantageously also in form-locking manner. This ensures that, for example after preassembly of the sensor device, the sensor element cannot fall out or change position prior to final installation in a cooktop in such a way as to have a negative impact on functioning thereof.

A stated trough-like sensor element receptacle may have, either as mechanical protection, for holding purposes or as thermal insulation, a wall on both sides of the sensor element laterally of or parallel to the longitudinal direction of said receptacle. These walls on the one hand result in the stated trough shape, and on the other hand may also fulfill the above-stated purpose. These two walls may preferably remain at least 20% to 50% below the highest point of the sensor element, advantageously relative to their vertical height or to the vertical height of the sensor element, so as to ensure that the sensor element actually forms the highest point of the sensor device. This allows it to rest reliably against the underside of a stated cooktop plate.

In a further development of the invention, the retaining means for the sensor element may be made integrally or in one piece of plastics material, particularly advantageously as a single part. Such manufacture is achievable using a plastics injection molding process, advantageously with a single plastics material. A possible plastics material may be a silicone, or alternatively other plastics with a heat resistance of up to 120° C. or even 200° C. Although the plastics material should have a degree of resilience, it should be neither too hard nor too soft. A hardness of between 30 Shore A and 80 Shore A, and preferably between 45 Shore A and 70 Shore A, is suitable here.

In a first basic development of the invention, the fastening portion may be at least as long as half the length of the retaining region or of the sensor element receptacle in the longitudinal direction thereof, i.e. of somewhat elongate configuration. It may preferably be significantly longer, as will be explained in greater detail below, advantageously twice or three times as long. At the same time, in this development of the invention the fastening portion may be shallow, in particular it should be of substantially uniform thickness. At its protruding free end alone can it be somewhat thinner, for case of introduction or insertion into a stated heating means. This is explained in more detail below.

In a further development of the invention, the fastening portion of the retaining means may have two, in particular precisely two, fastening projections on one side of the retaining means, wherein a fastening recess is provided between these fastening projections or is formed thereby. The fastening recess has two opposing parallel sides and may in particular be rectangular in shape. These opposing sides are then in each case formed by an inwardly or mutually facing side of said fastening projections. In this respect, the fastening projections and the fastening recess therebetween advantageously lie in a plane which is parallel to a cooktop plate. Such fastening projections may then protrude laterally from the retaining means by between 300% and 600% of the above-stated length of the retaining region or of the sensor element receptacle.

In a preferred further development of the invention, fastening portions may in each case protrude in opposing directions from the two opposing long sides of the retaining means. They may on the one hand be similar in that two fastening projections with a fastening recess therebetween are in each case configured on the two fastening portions, as explained above. According to one option, these two opposing fastening portions may be of identical or mirror-image configuration. Alternatively, the length may be significantly greater on one side than on the other side, wherein the width of the fastening recesses is preferably the same. For instance, in the case of mounting between two heating means solely the one side with the longer fastening projections may serve in securing in position or protecting against displacement or rotation in a plane parallel to the cooktop plate. The shorter fastening portion on the opposing side has then merely to ensure final fixing, which is more straightforwardly possible.

In a second basic development of the invention, a fastening portion of the retaining means, advantageously every fastening portion of the retaining means, may be shorter than half the length of the retaining region or of the sensor element receptacle, specifically in the above-stated laterally protruding direction. It may even be shorter than 25%. Two such short fastening portions, in particular identically configured fastening portions, are then preferably provided on opposing sides of the retaining means. In this case, an upper edge portion and a lower edge portion are advantageously provided at the top and bottom of such a fastening portion and parallel to the retaining region, said edge portions extending as fastening projections and in each case having a fastening recess between them. This fastening recess should be of at least substantially uniform height, and extend in a level plane. This serves, as is explained below in greater detail, to ensure that the retaining means can be slipped onto a thin plate or sheet of a heating means so as to be held thereagainst. Along the two sides of the retaining means the fastening portions are advantageously of identical configuration, i.e. are mirror images. Here too, the fastening portions may advantageously protrude in opposing directions from the retaining means, although much less far than with the above-stated first basic development.

While the above-described sensor element receptacle is intended, with or without sensor element, to form the uppermost region of the sensor device on the retaining region, said fastening portions may form the lowermost region. The sensor device thus has a relatively low height, i.e. is of substantially shallow configuration. In this way, the structural height is not increased unnecessarily on installation into a cooktop below a cooktop plate, the sensor element needing merely, as described above, to protrude somewhat upwards beyond the heating means.

A heating means according to the invention, which has at least one induction heating coil and at least one above-stated sensor device, may have at least two inherently stable surface portions. These should be of electrically insulating configuration. Advantageously, they consist of or comprise micanite, and may thus take the form of thin micanite sheets. The thickness thereof may be between 0.3 mm and 2 mm. The induction heating coil is arranged at these surface portions, which advantageously extend in each case in parallel planes. The induction heating coil is particularly advantageously arranged between two such surface portions. A stated sensor device according to the invention is then mounted to an outer edge of the induction heating coil and in part between said two surface portions, wherein to this end the fastening portion engages at least in part between the surface portions. In this respect, it should engage largely or entirely without play for precise, positionally accurate arrangement of the sensor element. Even if the heating means has more than two such surface portions, for example three surface portions, it is sufficient for two of these surface portions to be used for mounting the sensor device or the retaining means to the heating means. This may be different depending on the above-described development of the retaining means. A retaining means according to the above-described first basic development may simply engage a long way or predominantly between the two surface portions and thus be secured in the vertical direction. To prevent horizontal movement, the long fastening portions may act on a component of the heating means or induction heating coil. Preferably, it may engage laterally over ferrite bars provided thereon, such that these lie in particular in the above-stated fastening recess. According to the second basic development of the invention, a retaining means may be slipped onto the edge of a surface portion, such that it is held substantially on this one surface portion but nevertheless engages in the region between this surface portion and the other surface portion.

Above-stated ferrite bars are preferably arranged on a surface portion, particularly preferably on a middle or lowermost surface portion of the heating means, preferably on the underside thereof. To this end, a receiving means known in principle from the prior art may be provided, for example in mesh-like configuration. These are sufficiently stable in any case to absorb the forces arising without risk of damage.

According to the above-described second basic development, the retaining means has a sort of horizontal slot between two fastening projections, wherein the retaining means is slid or pressed with this slot onto an outer edge of an above-stated surface portion. The sensor device may also be mounted in this way to a heating means. If such fastening projections with a slot therebetween are provided at the two opposing long sides of the retaining means, the sensor device may be mounted to the outer edges in a narrow interspace between two neighboring induction heating coils or heating means. This provides mounting which is stable and secure against tilting, slipping or displacement. Said mounting may in particular also readily absorb forces from above, which arise when the sensor device with sensor element is pressed with a certain contact force against the underside of the cooktop plate.

In one embodiment of the sensor device, at least one fastening projection can have latching means in order to be fastened to a heating means by means of latches or to be latched in. Advantageously, two fastening projections are provided on the sensor device, which have similar latching means. For this purpose, the latching means can have a spring-like latching tongue, the spring direction of which can be at right angles to the longitudinal extension of this fastening projection and/or at right angles to the surface of the heating means. In a further embodiment, the latching tongue can be surrounded in a frame-like manner by the remaining fastening projection, so that it is protected when inserted into a latching chamber or latching receptacle of a holding receptacle or the like on the heating means. Furthermore, the fastening projection can thus determine the alignment of the fastening of the sensor device on the heating means, while the latching means can ensure that this fastening does not come loose so easily.

A holding receptacle is advantageously designed as a separate part and arranged or fastened between two plain parts of the heating means, in particular glued between them. Advantageously, this can be at the level of the aforementioned ferrite bars. The holding receptacle can have at least one latching chamber for inserting the fastening portion or the fastening projection with the aforementioned latching tongue, whereby the alignment can be fixed as a result. A latching projection is preferably provided in the latching chamber as part of the aforementioned latching means, and the latching tongue engages behind this latching projection when inserted as a latching connection or for securing it. Advantageously, the latching chamber can completely surround the fastening projection, whereby the aforementioned secure alignment can be achieved.

A cooktop according to the invention has multiple above-described heating means and multiple above-described sensor devices. Precisely one single sensor device is arranged or provided between two heating means, wherein this sensor device is mounted to precisely these two heating means. With regard to the cooktop, provision may be made for such a sensor device, in particular precisely one single such sensor device, to be provided in each intermediate region between two neighboring heating means or heating means with neighboring long sides. The heating means may advantageously have a rectangular or approximately rectangular periphery, the long sides of this rectangle being the outer sides of the heating means. In particular, they or the outer edges are formed by the above-stated surface portions of the heating means.

If the cooktop has the heating means in two directions at right angles to one another, i.e. for example more than two heating means in one direction and at least two heating means in the direction at right angles thereto, a corresponding number of sensor devices can be provided. If the sensor devices have temperature sensors as the sensor elements, a temperature may in each case be determined using them in an intermediate region between two neighboring heating means, in particular thereover. Temperature determination substantially in the middle of the surface of the heating means advantageously proceeds using per se known temperature sensors in the surface region or in the central region of the heating means. As explained above, with induction heating means in particular, a central temperature sensor as conventionally provided in this case may be used.

These and further features are revealed in the description and in the drawings as well as in the claims, wherein the individual features can each be realized singly or severally in the form of sub-combinations in one embodiment of the invention and in other fields, and can represent advantageous and per se protectable embodiments, for which protection is claimed here. The subdivision of the application into individual sections and subheadings does not limit the general validity of the statements made thereunder.

### BRIEF DESCRIPTION OF THE DRAWINGS

Exemplary embodiments of the invention are illustrated schematically in the drawings and explained in more detail below. In the drawings:

FIG. 1 is a simplified sectional representation through a cooktop according to the invention,

FIG. 2 is a plan view onto the cooktop of FIG. 1 without cooktop plate and depicting the heating means according to the invention,

FIG. 3 is an oblique illustration of a sensor device according to the invention, as installed in the cooktop of FIGS. 1 and 2,

FIG. 4 is a plan view onto the sensor device of FIG. 3,

FIG. 5 is an oblique view from above onto a heating means according to the invention corresponding to FIG. 2 with a sensor device of FIG. 3 attached thereto,

FIG. 6 is an oblique view from below onto the heating means together with sensor device of FIG. 5,

FIG. 7 is an oblique view from below corresponding to FIG. 6 with a further heating means, wherein the lowermost micanite sheets of the heating means have been omitted,

FIG. 8 is a plan view from above onto the arrangement of the two heating means of FIG. 7,

FIG. 9 shows a retaining means for a sensor device similar to that of FIG. 3, in which a fastening portion is provided on just one side,

FIG. 10 is an oblique representation from above of a further retaining means for a sensor device, which has fastening portions on both long sides, it being possible to slip these onto micanite sheets of two neighboring heating means,

FIG. 11 is an oblique representation similar to FIG. 5 of an arrangement of a sensor device with a retaining means according to FIG. 10 between the heating means and

FIG. 12 is a slightly oblique sectional representation through the arrangement of FIG. 11,

FIG. 13 is an oblique view similar to FIG. 3 of an alternative holding device for a sensor device with two protruding fastening projections having latching tongues,

FIG. 14 is an illustration of a holding receptacle as a separate part,

FIG. 15 is an oblique view from above of a further heating device according to the invention similar to FIG. 6 with a holding receptacle from FIG. 14 attached to it,

FIG. 16 is a sectional view through the heating device of FIG. 15, to which the sensor device of FIG. 13 is attached by insertion, and

FIG. 17 is an oblique view of the heating device from FIG. 16.

### DETAILED DESCRIPTION OF THE EXEMPLARY EMBODIMENTS

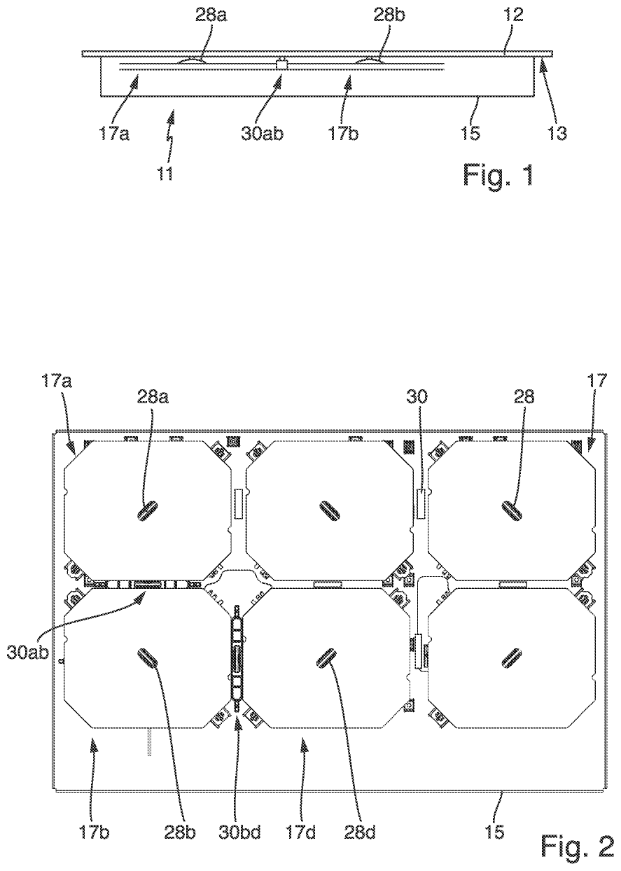

FIG. 1 shows a cooktop 11 according to the invention in lateral sectional representation, here viewed from the left-hand side. The cooktop 11 has a cooktop plate 12 with a cooktop plate underside 13. A housing 15 is arranged under the cooktop plate 12, which housing 15 can be of conventional configuration and contains the usual operating means for the cooktop 11. Two heating means 17a and 17b are shown, which are configured for inductive heating, as will be demonstrated in greater detail below. They are in each case pressed resiliently against the cooktop plate underside 13. Supplementary temperature sensors 28a and 28b are arranged respectively on the top of the heating means 17a and 17b, and rest directly against the cooktop plate underside 13. The purpose or use thereof is known to a person skilled in the art. Between the two heating means 17a and 17b, and mounted to both thereof, there is arranged a sensor device 30ab according to the invention. Together with these two means, it is likewise pressed against the cooktop plate underside 13 and serves to detect the temperature of the cooktop plate 12. This temperature may be influenced by cooking vessels placed thereover, which are placed over both heating means 17a and 17b, for example very large saucepans or casserole dishes. The then higher temperature over and at the sensor device 30ab allows the presence of a cooking vessel thereover to be confirmed or verified. These functions of the sensor device according to the invention for temperature detection are known to a person skilled in the art, however, and do not need to be explained here in any greater detail.

FIG. 2 shows a plan view which, as it were, shows the cooktop of FIG. 1 from above, but with cooktop plate 12 removed to reveal the arrangement therebelow. Six heating means 17 are arranged in the housing 15, in particular the heating means 17a, 17b and 17d specified in more detail. Above-mentioned supplementary temperature sensors 28a, 28b and 28d are respectively arranged on these heating means, specifically relatively centrally. With regard to the sensor element arranged thereon, these supplementary temperature sensors 28 may correspond to those of the sensor devices 30, merely with somewhat different mounting. Between the two heating means 17a and 17b there is arranged precisely one single sensor device 30ab, specifically substantially in the narrow interspace therebetween. It is provided approximately in the middle of the long side. Between the two heating means 17b and 17d there is provided a corresponding sensor device 30bd, again in the form of a single sensor device arranged therebetween. As indicated, further such sensor devices, in particular of identical configuration, are provided between all respectively directly neighboring heating means 17, specifically in each case in the region in which they lie with their long sides parallel and adjacent one another. In this way, it is possible to detect in these intermediate regions both a corresponding temperature at the cooktop plate 12 and for example thereby the presence of a heated saucepan.

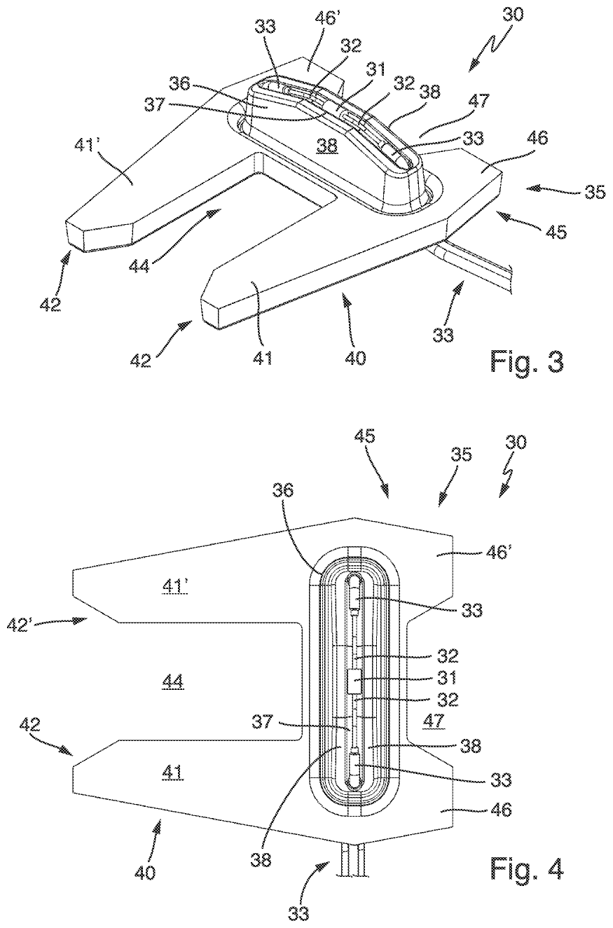

FIG. 3 is an oblique representation of a sensor device 30 according to the invention in a first development, FIG. 4 showing it from above. The sensor device 30 has a retaining means 35 for a temperature sensor 31, wherein the temperature sensor 31 is arranged in such a way thereon that it forms the highest point thereof, as is for example readily conceivable from FIG. 12. In this way, it may be ensured that the temperature sensor 31 also actually rests in any case against the cooktop plate underside 13, in accordance with FIG. 1. If still further parts, in particular of the heating means 17, such as for example the supplementary temperature sensors 28, were to rest against the cooktop plate underside 13, this would not be a problem. This temperature sensor 31, however, must in any case rest thereagainst.

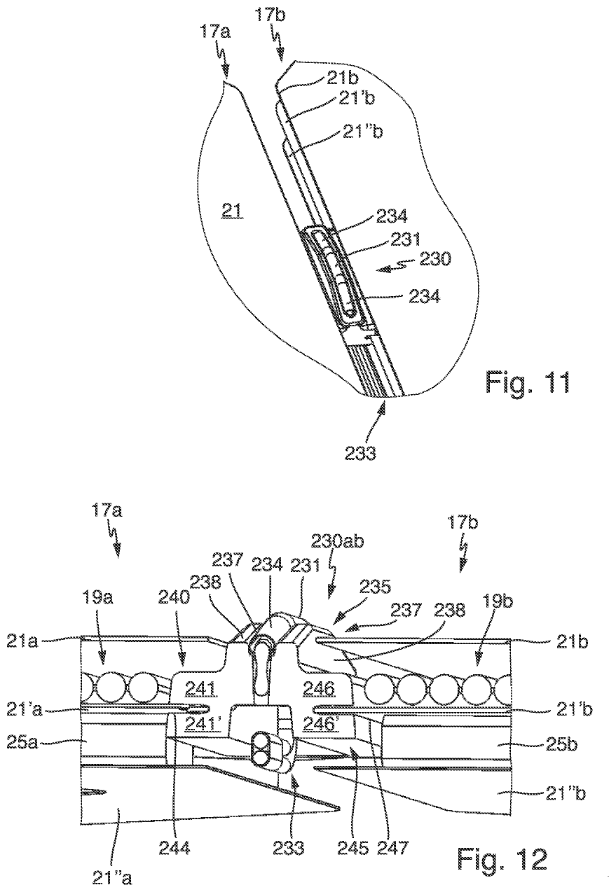

The temperature sensor 31 has sensor connectors 32 on both sides, here configured as protruding wires. Thus, the temperature sensor 31 may be configured in the manner of a THT component or as a THT component, so ensuring a wide selection and low costs. The sensor connectors 32 are each connected with a connecting cable 33. The connecting cables 33 in each case extend downwards through the retaining means 35 and are guided away laterally next to one another, here to the right or downwards. This is also readily apparent from the plan view of FIG. 4. The sensor connectors 32 exposed in FIGS. 3 and 4 and their connection to the connecting cables 33 may in practice of course once again be electrically insulated, for example by thin slip-on tubes, for example of silicone, Teflon or glass fiber fabric. This is known per se from the prior art and is also depicted further to the back in FIGS. 11 and 12.

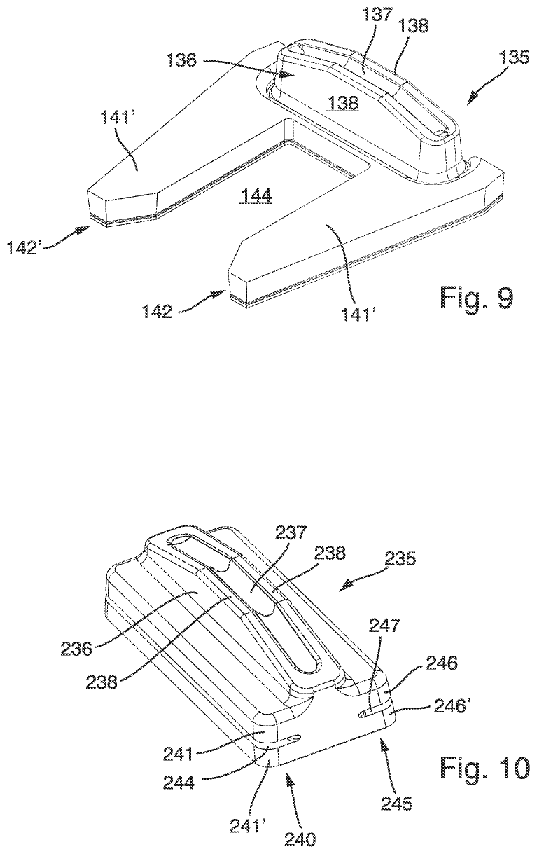

The retaining means 35 for the temperature sensor 31 consists on the one hand of a retaining region 36, which takes the form of a raised region. The retaining region 36 has a sensor element receptacle 37 at the top, this having two parallel walls 38 which between them form a trough-like receptacle for the temperature sensor 31. In this way, the sensor element receptacle 37 is configured as a trough. In this respect, reference is also made to FIGS. 9 and 10, whose alternatively configured retaining means show nevertheless identically configured retaining regions. Through the relative spacing of the two walls 38 the temperature sensor 31 is held precisely positioned between them, and cannot therefore be moved to and fro. It thus reliably forms the highest point of the sensor device 30. The temperature sensor 31 is secured substantially against movement in the longitudinal direction thereof by the guidance of the connecting cables 33. Although these connecting cables 33 are merely guided through the retaining region 36 and do not need to be additionally fastened, for example clamped or adhesively bonded, the identifiable multiple bending thereof provides fastening thereof and/or prevents any displacement.

The described retaining region 36 is arranged on a fastening portion 40 or is connected with such. The fastening portion 40 has two fastening projections 41 and 41′, which point forwards and to the left and are elongate and in each case have ends 42 and 42′ which taper widthwise. These tapered ends 42 and 42′ serve to facilitate insertion, which will be explained in greater detail below. The thickness of the fastening projections 41 and 41′ may also become thinner towards the tapering ends 42 and 42′, in order to be still more easily inserted in this regard too.

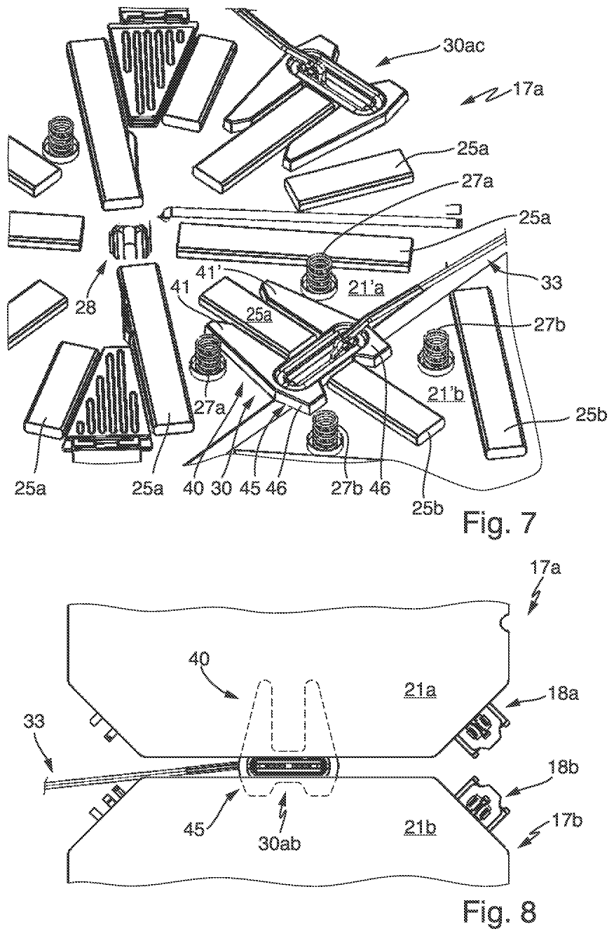

The protruding fastening projections 41 and 41′ have a fastening recess 44 between them, which is of rectangular configuration, in particular as a result of the parallel inner sides of the fastening projections. The retaining means 35 and thus the entire sensor device 30 may thus be pushed onto a ferrite bar, as is explained in greater detail in relation to FIG. 7.

On the opposing long side of the retaining region 36, a further fastening portion 45 is provided, which is advantageously configured in the same plane and with the same thickness as the fastening portion 40. This fastening portion 45 has two significantly shorter fastening projections 46 and 46′, which have a significantly shorter fastening recess 47 between them. As will become clear later from FIG. 7, this fastening recess 47 may also engage over a ferrite bar, but offers much less of a close fit. This does not constitute a problem, however, since the retaining effect is provided primarily by the fastening portion 40. Such a sensor device 30 or retaining means 35 may be made from plastics material, in particular sufficiently heat-resistant plastics material. Said material may possibly be a relatively soft or resilient plastics material, as explained above.

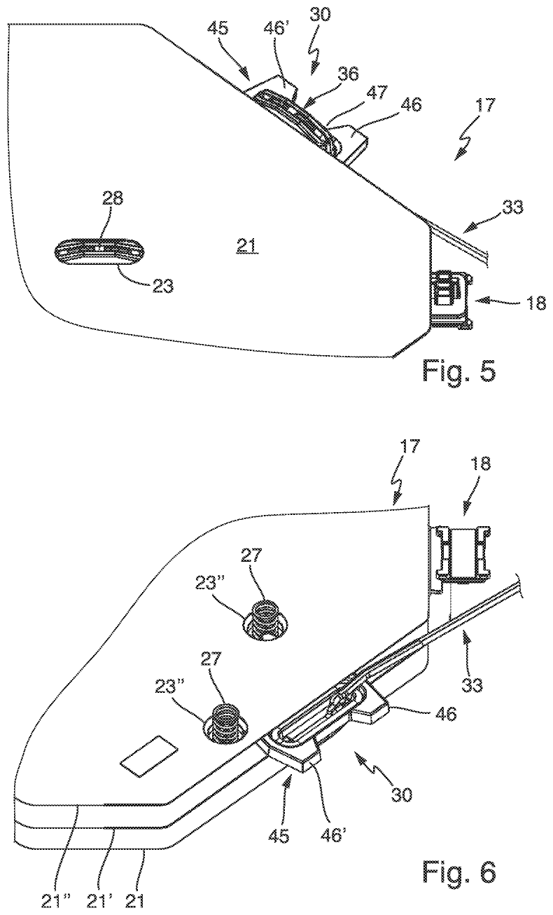

FIGS. 5 and 6 show, in oblique views from above and below, how a sensor device 30 of FIGS. 3 and 4 is inserted laterally into a heating means 17. It should be said in relation to heating means 17, also in anticipation of FIG. 12, which shows identical heating means 17, that induction heating coils 19a and 19b are wound spirally in a plane in known manner from thick litz induction wire. These induction heating coils 19a and 19b are arranged respectively between pairs of micanite sheets 21a and 21′a and 21b and 21′b respectively, wherein here somewhat more spacing may definitely be provided than the height of the induction heating coil 19, see FIG. 12. A plurality of ferrite bars 25a and 25b of different lengths are respectively arranged, in particular firmly adhesively bonded, on the underside of the micanite sheets 21′a and 21′b, in the pattern shown in FIG. 7. These ferrite bars 25a and 25b are all in each case of the same thickness, in particular in each case also of the same width, but of different lengths. They are oriented substantially in the radial direction and point towards a center point of each heating means 17a and 17b, at which a supplementary temperature sensor 28 already explained above is arranged. Moreover, helical springs 27a and 27b are respectively arranged on the underside of the micanite sheets 21′a and 21′b, advantageously in specially configured holders. According to FIG. 6, these may pass through corresponding openings 23″ in a third, lowermost micanite sheet 21″a or 21″b respectively. They may lie in an intermediate plane in the housing 15 of FIG. 1 and press the respective heating means 17 resiliently upwards against the cooktop plate underside 13. According to FIG. 5, in the uppermost micanite sheet 21 a recess 23 for the supplementary temperature sensor 28 is also apparent. Thus, the latter protrudes upwards, but may have a retaining means which is, for example, configured similarly to the described retaining means 35 and is arranged and fastened between two micanite sheets 21.

As is clear from a comparison of FIGS. 6 and 7, a retaining means 35 of the sensor devices 30ab and 30ac in each case engages between the middle micanite sheet 21′a and 21′b and a lowermost micanite sheet 21″. The two long fastening projections 41 and 41′ here extend outwards parallel to the ferrite bars 25a, over which they engage. In this way, they are secured against displacement or rotation in the plane parallel to the micanite sheets. Since ferrite bars 25b of the respective other heating means 17b engage from the other side in the fastening recess 47 of the fastening portion 45, movement in the longitudinal direction away from the respective ferrite bar 25 is also prevented. Furthermore, through the arrangement of the fastening projections 41 and 46 between the middle and lowermost micanite sheets, retention in the vertical direction is ensured and secured, so ensuring that the temperature sensors 31 press against the cooktop plate underside 13.

From the plan view in FIG. 8 it is apparent that the sensor device 30ab is arranged with the retaining region 36 between the heating means 17a and 17b or the uppermost micanite sheets 21a and 21b thereof. The edge thereof may then rest on the walls 38 of the retaining region 36. Dashed lines show the fastening portions 40 and 45, which engage between the middle and lowermost micanite sheets and so secure the sensor device 30ab. There the respective fastening projections of the fastening portions 40 and 45 engage over ferrite bars (not shown) and ensure positionally accurate mounting, as explained above. For installation of a cooktop 11, provision may be made firstly for example for the heating means 17a to be placed in an intermediate plane in the housing 15 and fastened with holders 18a provided at the corners. Then the sensor device 30ab may be fastened thereto by inserting the fastening portion 40 into the heating means 17a. Electrical connection may be made using the connecting cables 33. The heating means 17b may then be positioned and, as it were, pushed onto the short fastening portion 45. It is then fastened using the holder 18b. In the next step a further sensor device 30 may in each case be pushed in at the sides pointing to the right of the heating means 17a, 17b, and so on.

FIG. 9 is an oblique representation similar to FIG. 3 of a retaining means 135 for a further sensor device, but without the temperature sensor and electrical connectors. This retaining means 135 is configured substantially like that of FIG. 3, i.e. it has an upwardly raised retaining region 136 with two walls 138, which form a trough-like sensor element receptacle 137 between them. This is also again of arcuate configuration, whereby it is ensured that the highest point is in fact achieved in the middle region, where in accordance with FIG. 3 the temperature sensor is arranged. The retaining region 136 is connected to a fastening portion 140, which protrudes into the heating means. The fastening portion 140 has two fastening projections 141 and 141′, which each have tapered ends 142 and 142′. A rectangular fastening recess 144 is formed therebetween, which is configured for pushing onto a ferrite bar. Unlike with the retaining means 35 of FIG. 3, however, only a single fastening portion 140 on one side is provided. Such a retaining means 135 may thus be provided for a sensor device which is not intended to be fastened to a neighboring heating means on the other side, in particular through engagement as previously explained. Alternatively, it may be arranged at an outward pointing edge of a heating means, meaning that there would be no space for a further fastening portion toward the outside. This is intended to illustrate that the above-mentioned variants are possible when it comes to how such a retaining means or such a sensor device can be configured, in particular with regard to the options for mounting thereof.

FIG. 10 shows yet another retaining means 235 for a corresponding sensor device, again without a temperature sensor as in FIG. 9. However, here too the upper region of a retaining region 236 is configured in the same way, with the two parallel walls 238 forming an arcuate trough-like sensor element receptacle 237 between them. Here too, therefore, the same temperature sensor can be arranged in the same way as in FIG. 3, as is readily conceivable. This retaining means 235 corresponds to the above-explained second basic development of the invention. The retaining region 236 is namely provided with two identical left and right fastening portions 240 and 245 forming mirror images. These consist respectively of upper fastening projections 241 and 246 and lower fastening projections 241′ and 246′. The two fastening projections guided parallel to one another in each case form fastening recesses 244 and 247 respectively between them. These fastening recesses 244 and 247 are of the same height, and towards the long side they may possibly be somewhat chamfered or flared. This facilitates the insertion of the edge portions of micanite sheets that are going to be inserted therein. It is apparent from the further figures, FIGS. 11 and 12, how the sensor device 230ab, when fully equipped with temperature sensor 231 and having a retaining means 235ab corresponding to FIG. 10, is arranged between two neighboring heating means 17a and 17b configured as previously described. The mutually facing marginal regions or edges of the middle micanite sheets 21′a and 21′b are in each case inserted into the fastening recesses 244 and 247, in particular as far as a limit stop, in order to retain the sensor device 230ab securely. The retaining region 236 here extends between the two heating means 17a and 17b, in particular between the upper micanite sheets 21a and 21b thereof, and protrudes upward therebeyond. It is clear from FIG. 12 that the temperature sensor 231 is arranged at the highest point. The electrical connectors thereof and the start of the connecting cables 233 may be covered with tubing 234 for electrical insulation purposes. It is also clear from the sectional representation of FIG. 12 that the upper fastening projections 241 and 246 engage between the upper and middle micanite sheets. Likewise the lower fastening projections 241′ and 246′ engage between the middle and lower micanite sheets 21″a and 21″b, as described above for the other fastening projections of the differently configured sensor devices or their retaining means. However, they do not engage with the ferrite bars 25a and 25b illustrated. As described above, as the cooktop is successively fitted with one heating means 17 after the other, these sensor devices 230ab may also be inserted or slipped laterally thereinto. The fastening action arises less, however, from this insertion than because the fastening projections of each fastening portion clamp the edge region of the middle micanite sheet firmly between them.

Force-locking clamping onto the middle micanite sheets may act against displacement of the sensor device 230ab in the longitudinal direction. Alternatively, a longer portion may again protrude from the lower fastening projections, as shown in FIG. 7, and as it were be fixed to a ferrite bar 25. In yet another development, a projection or a recess may also be provided at the edge of one middle micanite sheet 21′ or of both middle micanite sheets 21′, which projection or recess interacts accordingly with a projection or a recess on or in the fastening portions of the retaining means 235 to counter displacement.

Due to the elongate configuration of the retaining region 236, lengthwise arrangement of the temperature sensor is very much possible, and the sensor connectors thereof and the associated connecting cables may likewise be well guided. The space provided between two neighboring heating means is well utilized, and no additional space is needed, and therefore they do not have to exhibit greater spacing. For the supplementary temperature sensors provided centrally on the heating means 17 it is possible to provide similar retaining regions and similarly configured temperature sensors, but possibly different or simpler and above all smaller retaining means.

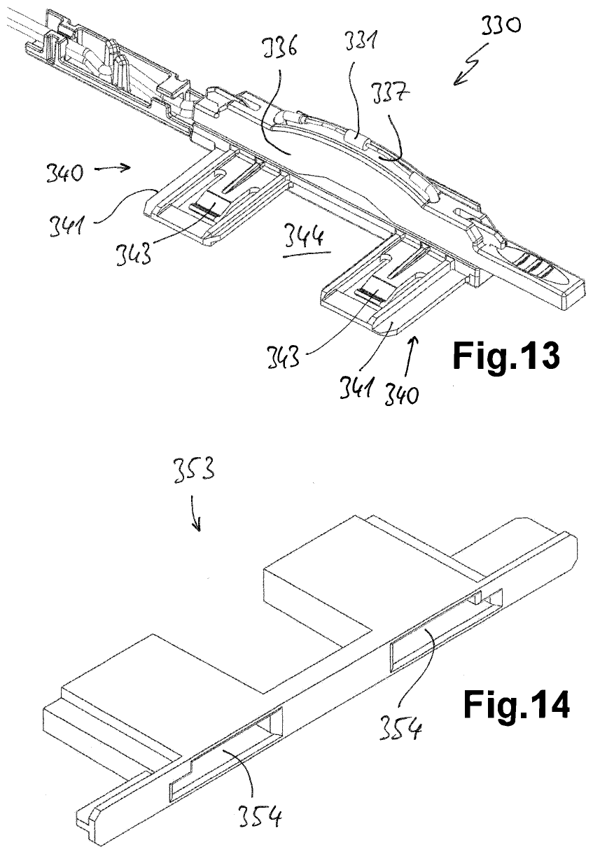

FIG. 13 shows a further embodiment of a sensor device 330 according to the invention, which is longer than that in FIG. 3 and has a longer retaining region 336, which carries a temperature sensor 331 on an upwardly curved sensor element receptacle 337. Two fastening portions 340 protrude at right angles to the side from the retaining region 336, forming a fastening recess 344 between them. The fastening portions 340 are each formed by fastening projections 341, which have a special profile. A latching tongue 343 is formed within each of the fastening projections 341, the cross-section of which can be seen approximately from the illustration in FIG. 16. While the two fastening projections 341 are mirror-symmetrical to each other, the two latching tongues 343 can be identical.

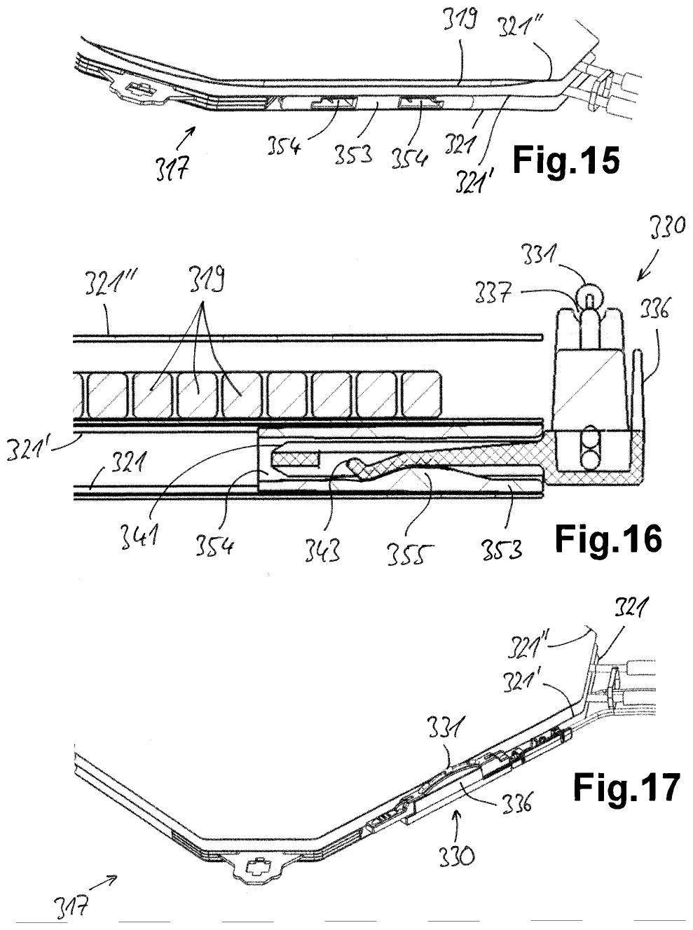

In FIG. 14, a holding receptacle 353 for the fastening projections 341 is shown as a separate plastic part. The holding receptacle 353 has two latching chambers 354, which are arranged at a distance corresponding to the fastening portions 340 of the sensor device 330. A ferrite bar 25a can be located in a space formed between the latching chambers 354 as shown in FIG. 7. The latching chambers 354 have an internal latching projection 355 according to the sectional view of FIG. 16 below, behind which latching projection 355 the front end of a latching tongue 343 engages for latching. According to FIG. 16, this prevents the sensor device 331 from being easily or even on its own removed from the heating device 317. As is also shown in the oblique representation of FIG. 15, the holding receptacle 353 is inserted between the two lower micanite sheets 321 and 321′ and advantageously glued therein. In this way, the holding receptacle 353 can be fixed or glued to the heating device 317 during its manufacture. An arrangement or assembly of the sensor device 330 on the heating device 317 can then be carried out even more easily, securely and accurately. Furthermore, the sensor device 330 then remains in a precisely defined position on the heating device 317 until it is installed in a cooktop with several other heating devices 317 as shown in FIG. 2.

1. A sensor device for a cooktop, wherein said sensor device has:
a sensor element, which sensor element has electrical connectors,
a retaining means for said sensor element,
wherein
said retaining means has an upper retaining region, in which said sensor element is held precisely in position in such a way to protrude beyond said retaining means,
said retaining region is elongate and has a length and a width, wherein said length amounts to at least 200% of said width,
said retaining means has a fastening portion being connected to said retaining region,
said at least one fastening portion protrudes in a direction approximately at right angles from a longitudinal direction of said retaining region,
wherein
said fastening portion has fastening projections and fastening recesses for form-locking fastening of said sensor device in an outer region of a heating means of said cooktop in such a way that at least one said fastening projection protrudes laterally for engagement into said heating means for fastening said sensor device to said heating means.

2. The sensor device according to claim 1, wherein said at least one fastening portion protrudes in a direction between 80° and 100° from a longitudinal direction of said retaining region.

3. The sensor device according to claim 1, wherein, in said retaining region, said retaining means has a trough-like elongate sensor element receptacle and said sensor element is arranged within said sensor element receptacle.

4. The sensor device according to claim 3, wherein said sensor element receptacle has, at least in a direction parallel to its longitudinal direction, a wall on either side of said sensor element, wherein said two walls remain at least 20% to 50% below a highest point of said sensor element.

5. The sensor device according to claim 1, wherein said retaining means is made integrally or in one piece from plastics material.

6. The sensor device according to claim 5, wherein said plastics material is a silicone with a hardness of between 30 Shore A and 80 Shore A.

7. The sensor device according to claim 1, wherein said fastening portion is at least as long as half a length of said retaining region in said longitudinal direction or wherein said fastening portion is shallow.

8. The sensor device according to claim 1, wherein said fastening portion has two fastening projections with a fastening recess therebetween, wherein said fastening recess has two opposing parallel sides, wherein said respectively opposing parallel sides in each case form one side of said fastening projections.

9. The sensor device according to claim 1, wherein fastening portions protrude in opposing directions from opposing sides of said retaining means.

10. The sensor device according to claim 9, wherein said fastening portions are of identical configuration or of mirror image configuration.

11. The sensor device according to claim 1, wherein one said fastening portion is shorter than half a length of said retaining region in its longitudinal direction, wherein an upper edge portion and a lower edge portion extend at a top and at a bottom of said fastening portion and parallel to said retaining region as fastening projections, in each case with a fastening recess of constant height between them.

12. The sensor device according to claim 11, wherein said same fastening projections and fastening recesses are provided along said two sides of said retaining region, wherein said fastening portions protrude in opposing directions.

13. The sensor device according to claim 12, wherein said fastening portions are of identical configuration or mirror image configuration.

14. The sensor device according to claim 1, wherein a fastening projection has latching means in order to be fastened to one said heating means by means of latches or to be latched in, wherein said latching means have a spring-like latching tongue, wherein a spring direction of said latching tongue is at right angles to a longitudinal extension of said fastening projection.

15. A heating means with an induction heating coil and with a sensor device according to claim 1, wherein said heating means has at least two inherently stable surface portions, on which said induction heating coil is arranged, wherein said sensor device is mounted at least to an outer edge of said induction heating coil and between said two surface portions and to this end said fastening portion engages between said two surface portions.

16. The heating means according to claim 15, wherein said at least two inherently stable surface portions consist of thin micanite sheets.

17. The heating means according to claim 15, wherein said fastening portion engages entirely without play between said two surface portions.

18. The heating means according to claim 15, wherein elongate ferrite bars are arranged on a bottom of one said surface portion, wherein said retaining means rests with two fastening projections against sides of a ferrite bar, such that said ferrite bar extends in a fastening recess lying therebetween.

19. The heating means according to claim 18, wherein said elongate ferrite bars are arranged on a bottom of said lowermost surface portion.

20. The heating means according to claim 15, wherein (a) one said fastening portion is shorter than half a length of said retaining region in its longitudinal direction, wherein an upper edge portion and a lower edge portion extend at a top and at a bottom of said fastening portion and parallel to said retaining region as fastening projections, in each case with a fastening recess of constant height between them and (b) said sensor device is arranged on said outside of said induction heating coil in such a way that at least one of said surface portions of said induction heating coil lies in said fastening recess of said retaining means.

21. The heating means according to claim 15, wherein said retaining means have a holding receptacle, and said holding receptacle is designed as a separate part and is arranged between two plain parts of said heating means, wherein said holding receptacle has at least one latching chamber for inserting said fastening projection.

22. The heating means according to claim 21, wherein latching means are provided and said fastening projection has a latching tongue, wherein a latching projection is provided in said latching chamber as part of said latching means, and wherein said latching tongue engages behind said latching projection when said fastening projection is inserted into said latching chamber.

23. A cooktop with multiple heating means according to claim 15 and with multiple sensor devices according to a sensor device for a cooktop, wherein said sensor device has:
a sensor element, which sensor element has electrical connectors,
a retaining means for said sensor element,
wherein
said retaining means has an upper retaining region, in which said sensor element is held precisely in position in such a way to protrude beyond said retaining means,
said retaining region is elongate and has a length and a width, wherein said length amounts to at least 200% of said width,
said retaining means has a fastening portion being connected to said retaining region,
said at least one fastening portion protrudes in a direction approximately at right angles from a longitudinal direction of said retaining region,
wherein
said fastening portion has fastening projections and fastening recesses for form-locking fastening of said sensor device in an outer region of a heating means of said cooktop in such a way that at least one said fastening projection protrudes laterally for engagement into said heating means for fastening said sensor device to said heating means, and
wherein precisely one single sensor device is arranged between at least two heating means.

24. The cooktop according to claim 23, wherein all said heating means are provided with elongate outer sides and such a sensor device is arranged between two neighboring heating means.

25. The cooktop according to claim 24, wherein precisely one such single sensor device is arranged between two neighboring heating means.

26. The cooktop according to claim 23, wherein always and in each case precisely one single sensor device is arranged between two neighboring heating means.
